(19) United States
(12) Patent Application Publication
(10) Pub. No.: US 2015/0293549 A1
(43) Pub. Date: Oct. 15, 2015

(54) LOAD PANEL SYSTEM

(71) Applicant: EATON CORPORATION, Cleveland, OH (US)

(72) Inventors: DHANANJAY LAL, HERNDON, VA (US); ANDREW J. FOERSTER, MCCANDLESS TOWNSHIP, PA (US); DAVID RAYMOND ROHN, VENETIA, PA (US); SANDY OMAR JIMENEZ GONZALEZ, MONACA, PA (US); RUBEN G. HERRERA, SANTO DOMINGO (DO); JASON K. A. OKERMAN, HUDSON, OH (US)

(73) Assignee: EATON CORPORATION, CLEVELAND, OH (US)

(21) Appl. No.: 14/251,771

(22) Filed: Apr. 14, 2014

(51) Int. Cl. G05F 1/66; G05B 15/02

(52) U.S. Cl. CPC G05F 1/66; G05B 15/02

(57) ABSTRACT

A load panel system includes a load panel having an enclosure; a plurality of circuit interrupters within the enclosure of the load panel; and a processor within the enclosure of the load panel. The processor includes a first communication medium structured to communicate first information to or from outside of the enclosure of the load panel, a second communication medium structured to communicate second information to or from the circuit interrupters within the enclosure of the load panel, and a non-volatile memory. The processor inputs a number load panel algorithms to the non-volatile memory after installation of the load panel and the processor in the load panel system. The processor executes the number of load panel algorithms employing at least the second information.

### BACKGROUND

1. Field

The disclosed concept pertains generally to systems including a load panel and, more particularly, to load panels including a processor, such as, for example, an aggregator, and a plurality of circuit interrupters.

2. Background Information

A load panel, such as a panelboard, load center or circuit breaker panel, holds a plurality of electrical switching apparatus each of which is electrically connected between a power source and a separate load.

Electrical switching apparatus include, for example, circuit switching devices and circuit interrupters, such as circuit breakers, contactors, motor starters and motor controllers. Circuit breakers are generally old and well known in the art. Such circuit breakers are used to protect electrical circuitry from damage due to an overcurrent condition, such as an overload condition or a relatively high level short circuit condition.

It is known to employ a controller, such as, for example, a computer, for controlling a plurality of circuit breakers in a panelboard. It is also known to employ the controller to monitor the status of the circuit breakers in a panelboard from the status contacts thereof.

U.S. Pat. No. 5,861,683 discloses a panelboard for power lines and loads and includes a plurality of circuit breakers housed by a housing, and a panelboard controller substantially housed by the housing. The panelboard controller includes a monitoring circuit for monitoring power or energy consumed in the circuits of the circuit breakers and a control circuit for controlling remotely controllable actuating circuits. Communications are provided to remotely monitor branch parameters, such as voltage, power and energy consumption. For electrical switching devices which provide the capability to energize or de-energize the branch circuit, these communications also allow this function to be performed remotely in order that a utility company and the energy consumer may remotely monitor and control branch circuit loads.

U.S. Pat. No. 6,084,758 discloses circuit breakers in an electric power distribution system, such as in a residence or a light commercial facility, that are remotely reclosed using a power line communications system such as an X10 or CEBus system, which transmits a reclose signal over power conductors to a recloser controlling the separable contacts of the circuit breaker in a load center.

U.S. Pat. No. 6,788,508 discloses a load center including a controller that controls a main circuit breaker and a plurality of branch circuit breakers, and provides a protection function and a monitoring function. A communications port provides a remote mechanism for inputting long delay, short delay and instantaneous trip setting values to be stored in memory designated for each branch circuit breaker and main circuit breaker. The communications port also provides a signal indicating the current flow within a selected circuit breaker and any trip setting value stored in local memory for viewing by a remote user. Remote utilization of the controller includes a remote digital input using a display based user interface having a display and a keypad combination that provides a digital menu, allowing settings to either be scrolled through or chosen with the keypad.

There is room for improvement in load panels for electrical switching apparatus.

### SUMMARY

These needs and others are met by embodiments of the disclosed concept in which a load panel system includes a load panel having an enclosure, and a plurality of circuit interrupters and a processor within the load panel enclosure. The processor includes a first communication medium to communicate first information to or from outside of the load panel enclosure, a second communication medium to communicate second information to or from the circuit interrupters within the load panel enclosure, and a non-volatile memory. The processor inputs a number load panel algorithms to the non-volatile memory after installation of the load panel and the processor in the load panel system, and executes the number of load panel algorithms employing at least the second information.

In accordance with one aspect of the disclosed concept, a load panel system comprises: a load panel including an enclosure; a plurality of circuit interrupters within the enclosure of the load panel; and a processor within the enclosure of the load panel, the processor including a first communication medium structured to communicate first information to or from outside of the enclosure of the load panel, a second communication medium structured to communicate second information to or from the circuit interrupters within the enclosure of the load panel, and a non-volatile memory, wherein the processor is structured to input a number load panel algorithms to the non-volatile memory after installation of the load panel and the processor in the load panel system, and wherein the processor is structured to execute the number of load panel algorithms employing at least the second information. As another aspect of the disclosed concept, a load panel system comprises: a load panel including an enclosure; a plurality of circuit interrupters within the enclosure of the load panel; and a processor within the enclosure of the load panel, the processor including a first communication medium structured to communicate first information to or from outside of the enclosure of the load panel, a second communication medium structured to communicate second information to or from the circuit interrupters within the enclosure of the load panel, and a number of load panel algorithms, wherein the processor is structured to execute the number of load panel algorithms employing at least the second information, and wherein the number of load panel algorithms include at least one of a load diagnostic algorithm for a number of loads powered by the circuit interrupters, a demand management algorithm for a plurality of loads powered by the circuit interrupters, and an awareness routine that determines whether a number of residents are at home based upon a number of loads powered by the circuit interrupters.

### BRIEF DESCRIPTION OF THE DRAWINGS

A full understanding of the disclosed concept can be gained from the following description of the preferred embodiments when read in conjunction with the accompanying drawings in which:

FIG. 1 is a block diagram of a load panel system including an aggregator having a number of load panel algorithms in accordance with embodiments of the disclosed concept.

FIG. 2 is a flowchart of a load diagnostic algorithm executed by the aggregator of FIG. 1.

FIG. 3 is a flowchart of a demand management algorithm executed by the aggregator of FIG. 1.

FIG. 4 is a flowchart of an awareness routine executed by the aggregator of FIG. 1.

### DESCRIPTION OF THE PREFERRED EMBODIMENTS

As employed herein, the term “number” shall mean one or an integer greater than one (i.e., a plurality).

As employed herein, the term “processor” shall mean a programmable analog and/or digital device that can store, retrieve, and process data; a computer; a workstation; a personal computer; a controller; an aggregator; a digital signal processor; a microprocessor; a microcontroller; a microcomputer; a central processing unit; a mainframe computer; a mini-computer; a server; a networked processor; or any suitable processing device or apparatus.

As employed herein, the term “load panel” shall mean a load center, a panelboard, a circuit breaker panel, or any suitable enclosure enclosing or housing a number of electrical switching apparatus for a number of branch or other load circuits.

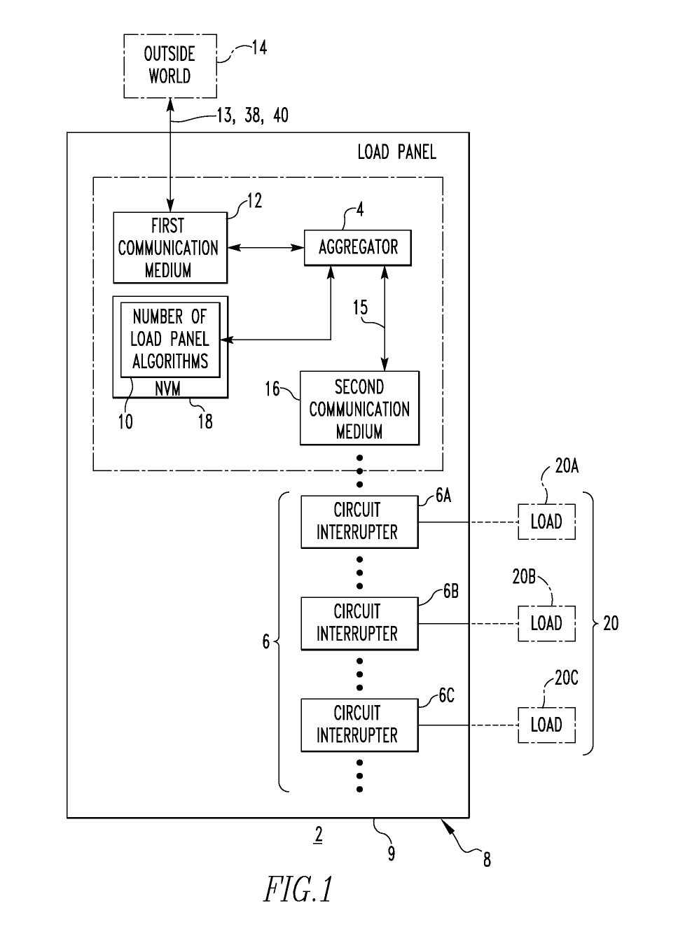

Referring to FIG. 1, a load panel system 2 includes a suitable processor, such as an aggregator 4, and a plurality of communicating circuit interrupters 6 (shown, for example, as 6A,6B,6C) inside a load panel 8, which includes an enclosure 9. The enclosure 9 encloses the aggregator 4 and the circuit interrupters 6. This enables the system 2 to be quickly retrofit to add a number of load panel algorithms 10 to the aggregator 4 and minimizes the total system complexity. The system 2 employs a first communication medium 12 between the aggregator 4 and the outside world 14 (shown in phantom line drawing), and a second communication medium 16 between the aggregator 4 and the circuit interrupters 6. For example and without limitation, this permits each of the two communication media 12,16 to be separately optimized (e.g., without limitation, this allows each communication medium to be tailored for a specific intent (e.g., low cost inside the load panel 8; easy connectivity for the outside world 14)). The aggregator 4 can execute a plurality of different load panel algorithms 10.

A non-limiting example of an aggregator, which communicates data and messages between a load panel and the outside world through a suitable communication channel is disclosed by U.S. patent application Ser. No. 13/894,541, filed May 15, 2013, which is incorporated by reference herein.

Another non-limiting example of a processor component, such as a central data aggregation unit, which can determine a plurality of digital power or energy values for a plurality of branch circuit breakers of a load panel and provide external network communications, such as for example and without limitation, TCP-IP protocols (e.g., without limitation, TCP Modbus) or RS-485 protocol (e.g., without limitation, Modbus®; other suitable communication protocols) is disclosed by U.S. patent application Ser. No. 13/888,626, filed May 7, 2013, which is incorporated by reference herein.

The first communication medium 12 of FIG. 1 can be, for example and without limitation, an Internet connection, a web server providing a web site over the Internet connection, a home area network (HAN), a wired communication network, a wireless communication network, a power line carrier communication network, a telephone interface, or a dedicated point-to-point link to/from another processor (e.g., part of 14).

The second communication medium 16 of FIG. 1 can be, for example and without limitation, a wired communication network, or a wireless communication network (e.g., without limitation, radio frequency (RF); optical; infrared).

Through the first communication medium 12, the aggregator 4 can input user-specified settings or preferences or installation-specific settings or preferences by a user (e.g., without limitation, a technician or vendor). These settings or preferences 13 include, for example and without limitation, any information a user, such as a technician, a home owner or a system manager, has control of after installation of the load panel 8. Several non-limiting examples of such information include “safe operating bounds” for load level, on/off cycles, transients, or unexpected changes for detecting normal versus non-normal or action-worthy behavior of any branch circuit or load. This information can also include “logic definitions” for triggering certain actions (e.g., without limitation, log entry; informational alerts;

alarms; shutting off power to a branch circuit or load). The settings or preferences 13 are saved in a suitable non-volatile local memory (NVM) 18, along with the number of load panel algorithms 10, by the aggregator 4, in order that any periods of loss of access to the outside world 14 over the first communication medium 12 do not inhibit execution of the load panel algorithms 10 by the aggregator 4. The aggregator 4 inputs the number load panel algorithms 10 to the NVM 18 after installation of the load panel 8 and the aggregator 4 in the load panel system 2. The aggregator 4 executes the number of load panel algorithms 10 employing at least a local collection of information 15. For example, the “most recent” set of settings 13 are used by the aggregator 4 as a logic base to make decisions, while using its local collection of information 15 (e.g., without limitation, nominal current of each of a plurality of loads 20 (shown, for example, as 20A,20B,20C); start-up current of each of the loads 20) from the circuit interrupters 6 over the second communication medium 16 as inputs to the number of the load panel algorithms 10.

For example, the aggregator 4 can be a real time or non-real time processor, which executes the load panel algorithms 10, even during periods of no access to the outside world 14 over the first communication medium 12, based on the most recently saved settings 13. For example and without limitation, the aggregator 4 executes all safety critical actions, and continues to collect periodic data from the circuit interrupters 6 even if connection to the outside world 14 through the first communication medium 12 is lost for an extended period of time.

As a further non-limiting example, the load panel 8 and the aggregator 4 can have one or more additional new load panel algorithms 10 added thereto at a date after installation of the load panel 8 and the aggregator 4. This is contrasted with known load panels, which are designed for fixed control and/or fixed monitoring of circuit breakers.

### EXAMPLE 1

A non-limiting example of a load panel algorithm 10 for a number of the loads 20 includes load diagnostics (e.g., without limitation, diagnosing one of the loads 20, such as a short-cycling air conditioning (AC) unit or refrigerator; diagnosing any load with periodic behavior (e.g., heater; security system; lighting circuit; water heater) that exhibits a non-routine behavior; diagnosing near end-of-life conditions for equipment with known typical current draw characteristics).

For example, “normal behavior” for a number of the loads 20, such as an appliance or other machinery, can be captured by one or more of: (1) on-site learning (e.g., without limitation, monitoring typical current/voltage/transient information of a number of the loads 20 for a suitable time (e.g., 1 day; 1 week; 1 month; 1 year depending on the application)); (2) one of the settings 13 being provided by the appliance or machinery vendor as safe and expected operating boundaries; (3) one of the settings 13 being added by the user, home owner or other resident; and (4) one of the settings 13 being added by the system installer based upon chosen settings for what is assumed to be normal versus non-normal behavior of a number of the loads 20.

In many known cases, end-of-life for equipment or servicing required for equipment are associated with loss of efficiency, and increased current draw. In some cases, a single set point for average current draw for a healthy device is all that needed as one of the settings 13. In addition, a suitable boundary envelope (e.g., without limitation, a percentage of average current draw or one or two limit values for current different from the average current draw) as one of the settings 13 triggers an alert (e.g., without limitation, an alert or other alarm is communicated to a user using the first communication medium 12).

Non-normal behavior can also be indicated by unexpected load transients. For example and without limitation, a motor system may be associated with very brief, relatively large current spikes during startup. Suitable boundaries as one of the settings 13 can be set on the spike duration, and if the current spike duration becomes longer by some margin, then this can be associated with an equipment problem. For example, this can trigger an alert (e.g., without limitation, an alert or other alarm is communicated to technical support for the equipment).

The frequency of ON versus OFF cycles of a number of the loads 20 can often indicate non-normal behavior that presents a problem. For example and without limitation, equipment, which typically only changes state less than once an hour or once a day, that has several state changes with less than 15 minutes in between can be associated with an equipment problem or even a dangerous condition. For example, this can cause one of the loads 20 to be turned off for a dangerous condition.

The expected boundaries on time periods of equipment being OFF versus ON as one of the settings 13 can often indicate non-normal behavior that presents a problem. For example and without limitation, if equipment that can only be left running safely for a number of hours exceeds that boundary, then that could trigger a suitable alert or a direct action (e.g., without limitation, turn off one of the loads 20 for a dangerous condition).

### EXAMPLE 2

FIG. 2 shows an example load diagnostic algorithm 30 executed by the aggregator 4 of FIG. 1. First, at 32, the aggregator 4 periodically obtains data from one of the circuit interrupters 6. Next, at 34, the algorithm 30 checks for normal behavior of the corresponding load 20 of FIG. 1 (e.g., as was discussed, above, in connection with Example 1). If the behavior is normal, which is typical, then execution repeats at 32. Otherwise, if non-normal behavior is indicated, then, at 36, the algorithm 30 chooses an appropriate action (e.g., as was discussed, above, in connection with Example 1). Non-limiting examples of such actions include: (1) at 38, alerting a user (e.g., without limitation, via an e-mail message; a text message; a suitable alarm or indication; an update of a web page with an alert or alarm condition) over the first communication medium 12 of FIG. 1; (2) at 40, alerting technical support for the corresponding load 20 (e.g., without limitation, equipment is in need of inspection or replacement) over the first communication medium 12 of FIG. 1; and (3) at 42, turning off the corresponding load 20 if there is a dangerous condition by commanding, at 44, the corresponding circuit interrupter 6 using the second communication medium 16 of FIG. 1.

In this example, the aggregator 4 employs the information 15 to or from the second communication medium 16 and employs the current or last available settings 13 from the first communication medium 12 of FIG. 1.

### EXAMPLE 3

Some other non-limiting examples of the load panel algorithms 10 of FIG. 1 include demand management (e.g., without limitation, turning off one of the loads 20, such as air conditioning (AC) or a water heater during peak times; dimming lighting) or load coordination (e.g., without limitation, only letting one of the loads 20 or another one of the loads 20 run at one time; automatic load balancing using a generator in order to shed or restore non-priority systems based on available energy level of a backup system).

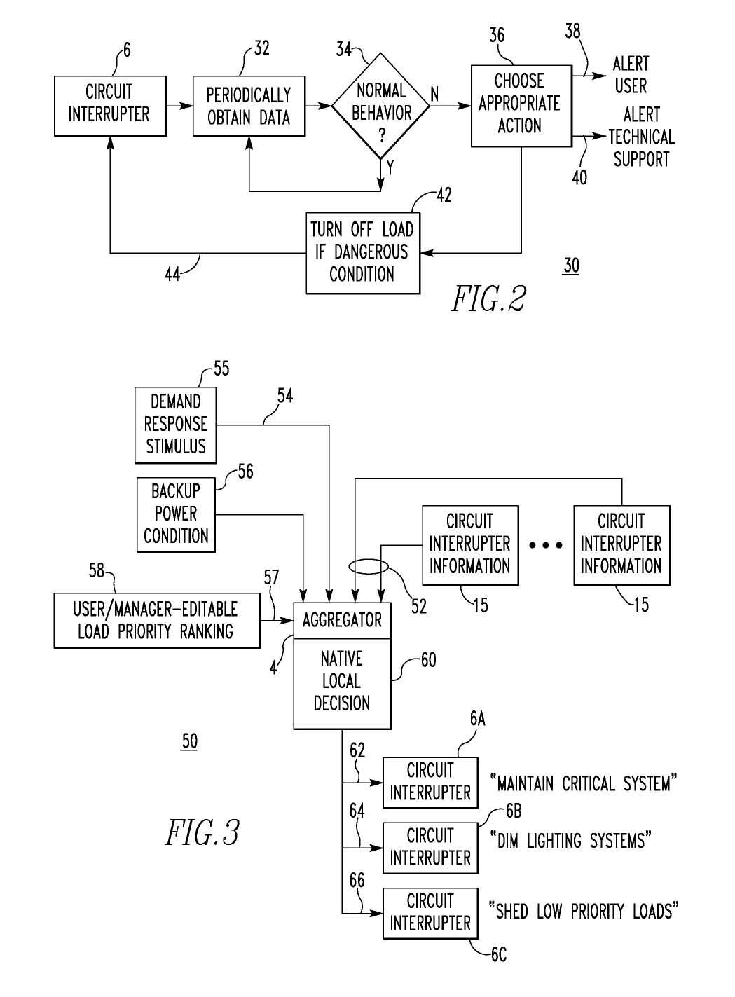

FIG. 3 shows an example demand management algorithm 50 executed by the aggregator 4 of FIG. 1. First, at 52, the aggregator 4 obtains the information 15 from each of the circuit interrupters 6 over the second communication medium 16 of FIG. 1. Next, at 54, the aggregator 4 considers a demand-response stimulus 55 obtained from the first communication medium 12, and inputs the condition 56 of backup power. Then, at 57, the aggregator 4 considers a user-edited load priority ranking 58 for some of the loads 20 powered by the circuit interrupters 6. Finally, at 60, the aggregator 4 makes a decision local to the load panel 8 of FIG. 1 to: (1) maintain critical systems for a number of the loads 20 at 62; (2) dim lighting systems for a number of the loads 20 at 64; and/or (3) shed a number of low priority loads for a number of the loads 20 at 66. The local information 15 (FIG. 1) can optionally include the commands at 44 (FIG. 2) and the commands at 62,64,66 (FIG. 3).

In this example, the aggregator 4 employs the information 15 to or from the second communication medium 16 and employs the current or last available settings 13 from the first communication medium 12 of FIG. 1.

### EXAMPLE 4

Another non-limiting example of a load panel algorithm 10 includes an awareness routine (e.g., without limitation, which monitors whether a number of residents have been at home (e.g., use of, for example, a lighting or heating system to indicate whether residents are at home (e.g., to warn of freezing temperatures))).

As a further non-limiting example, a determination of whether residents have been at home can involve detecting whether one or more light circuits have assumed both an on state and an off state in a 24 hour period. Also, a determination of whether residents have not been at home can involve determining whether a user turned down a thermostat in winter when away by determining that actual heating power consumption was less than an expected winter baseline (or was less than an actual baseline based upon the average daily temperature obtained over the Internet from the first communication medium 12). Alternatively, a determination of whether residents have not been at home can involve determining whether a user turned up a thermostat in summer when away by determining that actual cooling power consumption was less than an expected summer baseline (or was less than an actual baseline based upon the average daily temperature obtained over the Internet from the first communication medium 12).

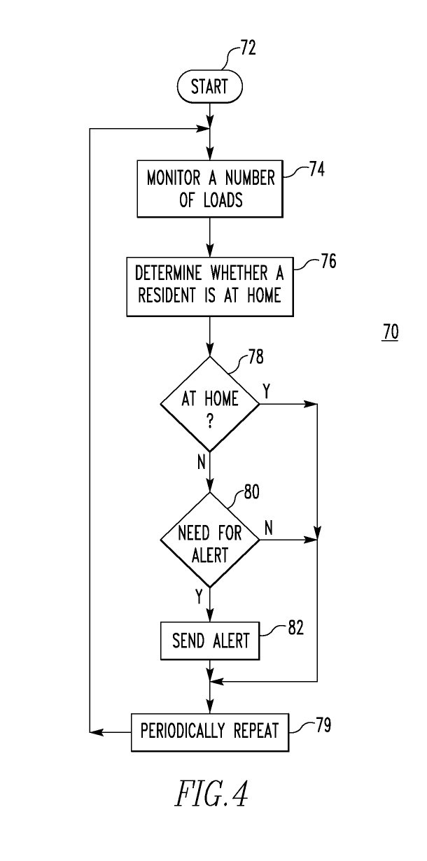

FIG. 4 shows an example awareness routine 70 executed by the aggregator 4 of FIG. 1. After starting, at 72, a number of the loads 20 of FIG. 1 are monitored at 74. Next, at 76, a determination is made of whether a resident is at home (e.g., as was discussed, above, in connection with this Example 4). If the decision was “at home”, at 78, then the algorithm 70 is periodically repeated after 79. On the other hand, if the resident was not at home and there is a need for an alert (e.g., as was discussed, above, in connection with Example 1), at 80, then an alert is sent at 82 over the first communication medium 12, before the algorithm 70 is periodically repeated after 79. On the other hand, if there was no need for an alert, then the algorithm 70 is periodically repeated after 79.

In this example, the aggregator 4 always employs the information 15 from the second communication medium 16 and does not require the settings 13 from the first communication medium 12 of FIG. 1.

### EXAMPLE 5

Decisions of when to alert a user, when to alert technical support, and when to turn off one of the loads 20 for a dangerous condition can be predefined by the load panel algorithm 10 of FIG. 1 and/or can be a user configurable parameter. User configuration and/or loading the number of load panel algorithms 10 can be accomplished over the first communication medium 12 and/or through a local communication port (not shown) of the aggregator 4.

### EXAMPLE 6

For example, the aggregator 4 can be positioned in a number of positions for the circuit interrupters 6 of the load panel 8 of FIG. 1, or alternatively can be separately positioned within the load panel 8. In this manner, the disclosed concept is able to use, for example, a conventional load center enclosure without specially cut steel or custom modifications. Hence, no hardware customization of the load panel 8 is required. For example and without limitation, the aggregator 4 can mount directly onto one or more (e.g., without limitation, four) circuit breaker slots and, therefore, has the advantages of being retrofittable and maximally flexible.

While specific embodiments of the disclosed concept have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the disclosed concept which is to be given the full breadth of the claims appended and any and all equivalents thereof.

What is claimed is:

1. A load panel system comprising:
a load panel including an enclosure;
a plurality of circuit interrupters within the enclosure of the load panel; and
a processor within the enclosure of the load panel, said processor including a first communication medium structured to communicate first information to or from outside of the enclosure of the load panel, a second communication medium structured to communicate second information to or from said circuit interrupters within the enclosure of the load panel, and a non-volatile memory,
wherein said processor is structured to input a number load panel algorithms to the non-volatile memory after installation of said load panel and said processor in said load panel system, and
wherein said processor is structured to execute said number of load panel algorithms employing at least the second information.

2. The system of claim 1 wherein said number of load panel algorithms are a plurality of different load panel algorithms.

3. The system of claim 1 wherein said circuit interrupters power a plurality of loads outside of the load panel; and wherein said number of load panel algorithms are a plurality of load diagnostic algorithms for some of said loads outside of the load panel.

4. The system of claim 3 wherein said load diagnostic algorithms diagnose either normal behavior or non-normal behavior for said some of said loads outside of the load panel.

5. The system of claim 4 wherein one of said some of said loads outside of the load panel is equipment; and wherein said non-normal behavior indicates one of end-of-life for the equipment or servicing is required for the equipment.

6. The system of claim 1 wherein said circuit interrupters power a plurality of loads outside of the load panel; and wherein one of said number of load panel algorithms is an awareness routine that determines whether a number of residents are at home based upon at least one of said loads outside of the load panel.

7. The system of claim 1 wherein said circuit interrupters power a plurality of loads outside of the load panel; and wherein one of said number of load panel algorithms is a demand management algorithm for some of said loads outside of the load panel.

8. The system of claim 1 wherein said circuit interrupters power a plurality of loads outside of the load panel; and wherein said number of load panel algorithms are configured to provide a number of: (1) an alert to a user over the first communication medium, (2) an alert to technical support for one of said loads outside of the load panel over the first communication medium, and (3) a command to turn off one of said loads outside of the load panel over the second communication medium.

9. The system of claim 1 wherein said processor is further structured to execute the number of load panel algorithms employing only said second information if connection to the outside world through the first communication medium is lost.

10. A load panel system comprising:
a load panel including an enclosure;
a plurality of circuit interrupters within the enclosure of the load panel; and
a processor within the enclosure of the load panel, said processor including a first communication medium structured to communicate first information to or from outside of the enclosure of the load panel, a second communication medium structured to communicate second information to or from said circuit interrupters within the enclosure of the load panel, and a number of load panel algorithms,
wherein said processor is structured to execute the number of load panel algorithms employing at least the second information, and
wherein the number of load panel algorithms include at least one of a load diagnostic algorithm for a number of loads powered by said circuit interrupters, a demand management algorithm for a plurality of loads powered by said circuit interrupters, and an awareness routine that determines whether a number of residents are at home based upon a number of loads powered by said circuit interrupters.

11. The system of claim 10 wherein said number of load panel algorithms are a plurality of different load panel algorithms.

12. The system of claim 10 wherein said first communication medium is selected from the group consisting of an Internet connection, a web server providing a web site over the Internet connection, a home area network, a wired communication network, a wireless communication network, a power line carrier communication network, a telephone interface, and a dedicated point-to-point link to or from another processor.

13. The system of claim 10 wherein said circuit interrupters power a plurality of loads outside of the load panel; and wherein said number of load panel algorithms are a plurality of load diagnostic algorithms for some of said loads outside of the load panel.

14. The system of claim 13 wherein said load diagnostic algorithms diagnose either normal behavior or non-normal behavior for said some of said loads outside of the load panel.

15. The system of claim 14 wherein one of said some of said loads outside of the load panel is equipment; and wherein said non-normal behavior indicates one of end-of-life for the equipment or servicing is required for the equipment.

16. The system of claim 10 wherein said circuit interrupters power a plurality of loads outside of the load panel; and wherein one of said number of load panel algorithms is an awareness routine that determines whether a number of residents are at home based upon at least one of said loads outside of the load panel.

17. The system of claim 10 wherein said circuit interrupters power a plurality of loads outside of the load panel; and wherein one of said number of load panel algorithms is a demand management algorithm for some of said loads outside of the load panel.

18. The system of claim 10 wherein said circuit interrupters power a plurality of loads outside of the load panel; and wherein said number of load panel algorithms are configured to provide a number of: (1) an alert to a user over the first communication medium, (2) an alert to technical support for one of said loads outside of the load panel over the first communication medium, and (3) a command to turn off one of said loads outside of the load panel over the second communication medium.

19. The system of claim 10 wherein said second communication medium is a wired communication network or a wireless communication network.

20. The system of claim 10 wherein said processor is further structured to execute the number of load panel algorithms employing only said second information if connection to the outside world through the first communication medium is lost.

21. The system of claim 10 wherein said processor is further structured to execute the number of load panel algorithms employing both of said first information and said second information.
